(19) United States
(12) Patent Application Publication
(10) Pub. No.: US 2009/0164130 A1
(43) Pub. Date: Jun. 25, 2009

(54) FLUORESCENCE-LIFETIME-BASED TOMOGRAPHY

(75) Inventors: Anand T. N. Kumar, Arlington, MA (US); David Alan Boas, Winchester, MA (US); Adrew K. Dunn, Arlington, MA (US)

Correspondence Address: FISH & RICHARDSON PC, P.O. BOX 1022, MINNEAPOLIS, MN, 55440-1022, US

(73) Assignee: GENERAL HOSPITAL CORPORATION

(21) Appl. No.: 11/917,023

(22) PCT Filed: Jun. 9, 2006
(86) PCT No.: PCT/US06/22524

§ 371 Date: Aug. 18, 2008

Related U.S. Application Data
(60) Provisional application No. 60/689,324, filed on Jun. 10, 2005.

(51) Int. Cl. G01N 21/64; G06F 19/00

(52) U.S. Cl. 702/19; 250/459.1

(57) ABSTRACT

Methods, apparatus (100), and computer program products for determining lifetimes and distribution of fluorophores (102) embedded in samples (104). Fluorophores are placed into the sample, light from a source (110) selected to excite the fluorophores illuminates the sample, light emitted from the excited fluorophores is detected by a device (138), and a time-domain analysis is performed on the detected emitted light to determine a three-dimensional distribution of the fluorophores in the sample.

### CROSS-REFERENCE TO RELATED APPLICATIONS

This application claims priority to U.S. Provisional Application Ser. No. 60/689,324, entitled “FLUORESCENCE-LIFETIME-BASED TOMOGRAPHY”, filed Jun. 10, 2005, the content of which is hereby incorporated by reference in its entirety.

### TECHNICAL FIELD

This invention relates to tomography-based analysis, and more particularly to time-domain analysis of a sample based on fluorescence lifetimes.

### BACKGROUND

Fluorescent dyes, or fluorophores, are extrinsic contrast agents that may be placed in a biological sample to investigate characteristics of the sample without having to perform invasive procedures. Such fluorophores become optically excited when illuminated with a light source projecting incident light at the sample, and thereafter emit light for a particular period of time. The light emitted by the fluorophores in the sample decays at a rate associated with the particular fluorophore.

The fluorophores that are placed in the sample can be chosen according to the way in which such fluorophores are known to interact with specific types of tissues. For example, it if it desired to determine if a particular type of cancerous tissue exists within the sample, fluorophores known to bond with that type of tissue may be injected into the sample, and their distribution yield within the tissue may subsequently be determined by projecting incident light at the sample to determine the response, if any, of those fluorophores. If it is determined that those fluorophores are present within the sample, the location of those fluorophores within the sample may be indicative of the presence of that particular cancerous tissue at the location identified.

There exist several techniques that use fluorophores to obtain data regarding the biological tissues into which they are embedded. These techniques include procedures based on microscopic resolution, such as fluorescence lifetime imaging microscopy (FLIM).

In FLIM, a thin tissue section stained with dye (fluorophore), is illuminated and imaged over a period of time to obtain a high resolution 2-D image having a visual resolution of a few microns. For each pixel, this results in a profile showing acquired light as a function of time. The lifetime of the fluorophores species embedded in the tissue can be extracted from these profiles, thereby enabling identification of the fluorophores species and providing information about the local environment in which the fluorophores are embedded. However, this technique generally cannot be applied to thick tissue sections.

For imaging larger, turbid media, such as small animals, one can use frequency domain fluorescence molecular tomography or fluorescence diffuse optical tomography. These method utilize the advances made in the theory of diffuse light propagation in conjunction with the development of several near infra-red fluorophores to image fluorescence within deep tissue. Currently existing algorithms tomographically resolve the in-vivo fluorescence yield and lifetime distribution from measured frequency domain or time domain data. In frequency domain analyses, the measured fluorescence signal at modulation frequency ω, at a detector position r_{d} due to excitation by a point source at rₛ is given by

U_{F}(rₛ,r_{d},ω)=Gₓ(rₛ,r,ω)Gₘ(r,r_{d},ω)F(r,ω).

where Gₓ and Gₘ are the continuous wave Green's functions, and the complex quantity F is given by,

$$F ( r , ω ) = \frac{η ( r )}{1 - iωτ ( r )} = {\sum }_{n} \frac{{η}_{n} ( r )}{1 - {iωτ}_{n}} .$$

The function η(r) in the above equation represents the contribution of the n^{th} fluorophore species, having a specific lifetime, that is embedded in the sample. Thus, the contributions from the multiple lifetime components are invariably mixed in a frequency domain reconstruction. As a result, the frequency domain analysis does not provide data about the distribution of individual fluorophores in the sample.

### SUMMARY

Disclosed herein are methods and apparatus that extend lifetime-based imaging techniques such as FLIM to non-invasive imaging of deep tissue, while also providing significantly better fluorescence contrast and resolution as compared to current diffuse optical techniques.

An aspect of the current approach that distinguishes it from existing techniques is the identification of the various lifetime components of the individual fluorophores within the medium (e.g., the specimen) that contribute to the overall, or aggregated, yield distribution within the medium, which may be a turbid medium. The lifetimes can be directly extracted from the raw time-domain data, and the localizations of their in-vivo origin can be subsequently obtained using the procedures described herein.

In one aspect, the invention features methods for determining a distribution of fluorophores embedded in a sample. The methods include placing fluorophores into the sample, illuminating the sample with light selected to excite the fluorophores, detecting emitted light from the excited fluorophores, and performing a time-domain analysis on the detected emitted light to determine a three-dimensional distribution of the fluorophores in the sample.

These methods can include one or more of the following embodiments.

The time-domain analysis to determine the three-dimensional distribution can be performed by extracting lifetime data corresponding to the excited fluorophores from the detected emitted light, computing, from the extracted data, corresponding amplitude coefficients, aₙ, representative of initial amplitudes of the emitted light, and at least in part on the basis of the amplitude coefficients aₙ, computing, at points r in the specimen, a distribution function, ηₙ(r).

The lifetime data can include time-dependent data indicative of time-dependent fluorophore excitation behavior, the time-dependent data corresponding to time-dependent curves, each time-dependent curve having a rising section and a decaying section. The amplitude coefficients aₙ can be computed by determining the value of the coefficients based at least in part on data representing a decaying section of a time-dependent curve.

Computing, at points r in the specimen, a value of distribution function, ηₙ(r), can include computing the value at least in part on the basis of data corresponding to a rising section of a time-dependent curve. Computing the amplitude coefficients aₙ can include applying a curve-fitting technique to the lifetime data. Computing the value of the distribution function ηₙ(r), can include obtaining a pre-determined weight matrix, Wₙ, based at least in part on the basis of a Green's function associated with the sample. The data may include time-dependent data representative of time-dependent fluorophore-excitation behavior, the time-dependent data corresponding to time-dependent curves, the time-dependent curves each having a rising section and a decaying section, where obtaining a pre-determined weight matrix, Wₙ, is further performed on the basis of data corresponding to the rising sections of the respective curves.

Emitted light from the excited fluorophores can be detected by intensifying light emitted by the excited fluorophores, and capturing the intensified light at a light detection device. Capturing the intensified light can include illuminating a CCD array.

The sample can have absorption coefficients μₐ such that the fluorophore lifetimes are longer than the intrinsic absorption time scale defined by (vμa)⁻¹ (where v is the velocity of light in the sample).

In another aspect, the invention features an apparatus for determining a distribution of fluorophores embedded in a sample. The apparatus includes a light source configured to illuminate the sample with light selected to excite the fluorophores, a light detection device configured to detect light emitted by the excited fluorophores, and a processing module configured to determine, based on a time-domain analysis performed on the detected light, a three-dimensional distribution of the fluorophores in the sample.

Embodiments of the apparatus can include any feature corresponding to any of the features as set forth above for the methods.

In another aspect, the invention features computer program products for determining a distribution of fluorophores embedded in a sample, the computer program products reside on a machine-readable medium for storing computer instructions that, when executed, cause a processor-based machine to receive data corresponding to detected light emitted from the fluorophores placed in the sample when the fluorophores are excited by illuminated light, and perform a time-domain analysis on the detected emitted light to determine a three-dimensional distribution of the fluorophores in the sample.

Embodiments of the computer program product can include any feature corresponding to any of the features as set forth above for the method.

In a further aspect, the invention features methods for determining lifetimes of fluorophores embedded in a sample comprising one or more tissue types. The methods include placing fluorophores having associated known intrinsic lifetimes into the sample, illuminating the sample with light selected to excite the fluorophores, detecting emitted light from the excited fluorophores, extracting lifetime data corresponding to the excited fluorophores from the detected emitted light, computing, from the extracted data, corresponding lifetimes τₙ representative of a decay time associated with the fluorophores when placed in the sample, and identifying at least one of the tissue types based on the difference between the computed lifetimes τₙ with the fluorophores inside the sample and the corresponding intrinsic lifetimes of the fluorophores.

These methods can include one or more of the following embodiments.

Emitted light from the excited fluorophores can be detected by intensifying light emitted by the fluorophores, and capturing the intensified light at a light detection device.

The light can be captured by illuminating a CCD array.

The sample can have an absorption coefficients μₐ such that the fluorophore lifetimes are longer than the intrinsic absorption time scale defined by (vμₐ)⁻¹.

In another aspect, the invention features an apparatus for determining lifetimes of fluorophores embedded in a sample having one or more tissue types, the fluorophores having associated known intrinsic lifetimes. The apparatus includes a light source configured to illuminate the sample with light selected to excite the fluorophores, a light detection device configured to detect light emitted by the excited fluorophores, and a processing module. The processing module is configured to extract lifetime data corresponding to the excited fluorophores from the detected emitted light, compute, from the extracted data, corresponding lifetimes τₙ representative of a decay time associated with the fluorophores when placed in the sample, and identify at least one of the tissue types based on the difference between the computed coefficients τₙ and the corresponding intrinsic lifetimes of the fluorophores.

Embodiments of the apparatus can include any feature corresponding to any of the features as set forth above for the methods.

In yet another aspect, the invention features computer program products for determining lifetime of fluorophores embedded in a sample comprising one or more tissue types, the fluorophores having associated known intrinsic lifetimes. The computer program products reside on a machine-readable medium for storing computer instructions that, when executed, cause a processor-based machine to receive data corresponding to detected light emitted from the fluorophores placed in the sample when the fluorophores are excited by illuminated light, and extract lifetime data corresponding to the excited fluorophores from the detected emitted light. The computer instructions further cause the processor-based machine to compute, from the extracted data, corresponding lifetimes τₙ representative of a decay time associated with the fluorophores when placed in the sample, and identify at least one of the tissue types based on the difference between the computed coefficients τₙ and the corresponding intrinsic lifetimes of the fluorophores.

Embodiments of the computer program product can include any feature corresponding to any of the features as set forth above for the methods.

Unless otherwise defined, all technical and scientific terms used herein have the same meaning as commonly understood as one of ordinary skill in the art to which this invention belongs. Although methods, materials, apparatus, etc., similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a schematic diagram of an exemplary embodiment of an apparatus for determining the locations of fluorophores embedded in a specimen.

FIG. 2 is a graph showing the captured time-dependent behavior of light emitted from fluorophores embedded in a specimen.

FIG. 3 is a flow chart of an embodiment of a procedure for determining the distribution for each of the fluorophores species embedded in a specimen.

FIG. 4A is a diagram showing a simulated setup, including a simulated homogenous slab, that was used in performing fluorophore distribution analyses for fluorophores placed in the slab.

FIGS. 4B-D are the simulation results obtained from the fluorophore distribution analyses performed on the fluorophores placed in the slab of FIG. 4A.

FIG. 5A is a diagram showing an experimental setup, including two tubes, that was used in performing fluorophore distribution analyses for fluorophores placed in the two tubes.

FIGS. 5B-D are the experiment results obtained from the fluorophore distribution analyses performed on the fluorophores in the tubes of FIG. 5A.

FIG. 6 is a diagram showing the complex plane spectrum and a possible contour for evaluating the Born approximation integral representing the detected intensity of light emitted from fluorophores.

FIG. 7 is a graph showing the decay time of simulated fluorescence signals for a range of optical properties (μₐ, μ′ₛ).

Like reference symbols in the various drawings indicate like elements.

### DETAILED DESCRIPTION

Disclosed herein are methods and apparatus that determine the three-dimensional distribution of fluorophore species in a biological or non-biological sample by performing a time-domain analysis on light emitted from the fluorophores. Also disclosed are methods and apparatus that enable determination and identification, based on lifetime analysis, of fluorophores embedded in the sample. The fluorophores in the sample emit light in response to the illumination of incident light on the sample that excites the fluorophores.

### A. Apparatus

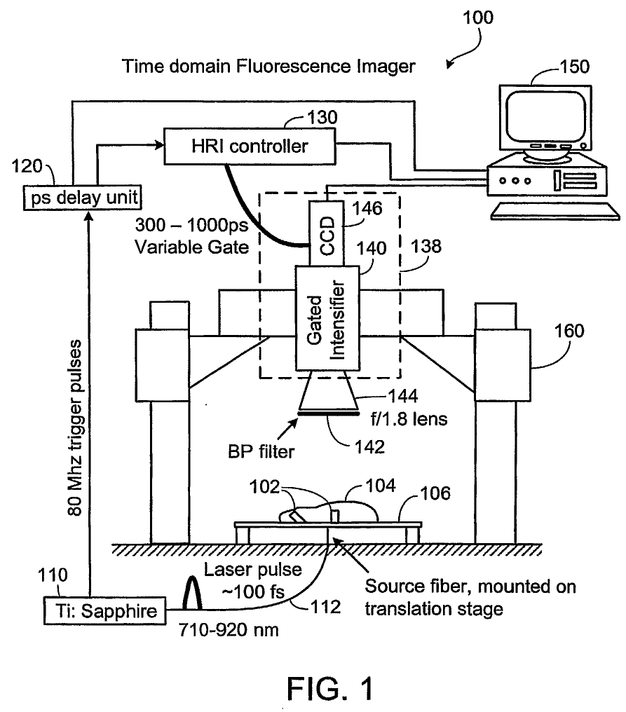

FIG. 1 is a schematic diagram of an exemplary embodiment of an apparatus 100 for determining the locations of fluorophores 102 corresponding to one or more fluorophore species embedded in a sample, e.g., in the tissue of a biological specimen 104. In some cases, the identity and characteristics of the fluorophores 102, including the lifetime of the fluorophores, is known a priori. In other cases, the identity of the fluorophore is determined from the analysis subsequently performed on captured images. The fluorophores 102 may be placed in the biological specimen 104 by injecting them into the specimen's tissue or through other procedure for placing, or embedding, the fluorophores in the specimen. The fluorophores 102 placed in the specimen 104 will subsequently settle in various locations throughout the specimen in accordance with, for example, those fluorophores' ability to bond or interact with different types of tissues of the specimen 104. Thus, for example, a particular fluorophore species that has a tendency to bond to a particular cancerous tissue may settle in large concentrations in portions of the specimen that have that cancerous tissue.

The emission of light from the excited fluorophores 102 decays over time. The period during which the intensity of the light emitted from a particular excited fluorophore decays to 1/e of its peak value, which is approximately ½ of the peak value, is referred to as the lifetime of the fluorophore. In general, different fluorophore species have different characteristic lifetimes. Additionally, the environment in which a particular fluorophore species is placed affects the lifetime of that fluorophore species. Thus, analysis of the lifetime of fluorophores placed inside the tissue of the biological specimen 104 provides insights into the properties of that tissue. In these cases in which the identity of the fluorophore is not known, the identity of the fluorophores embedded in the specimen can be determined based on the observed lifetimes.

The characteristics of a fluorophore 102, for example its lifetime, decay curve, brightness, wavelength of the omitted light, etc., may be controlled to behave in a specific way inside the bio-chemical environment in which it is placed. In some cases, fluorophores 102 are chosen or designed so that they are excited only when illuminated by light of a particular frequency or range of frequencies.

In some cases, the tissue of the biological specimen 104 is turbid, or is so thick (e.g., more than 0.5 cm) that conventional procedures for determining individual fluorophore distributions within the tissue are ineffective.

Referring back to FIG. 1, the biological specimen 104 is placed on a translation stage 106 that displaces the specimen 104 relative to, for example, a camera or a light source. The translation stage 106 thus enables the repositioning of the specimen 104 so that different portions of the specimen 104 may be illuminated and/or viewed. Movement of translation stage 106 is controlled automatically using, for example, a computing device, or manually through manual control of an actuation mechanism.

The apparatus 100 includes a light source 110 in optical communication with the specimen 104 for exciting the fluorophores 102 in the specimen 104. A suitable light source 110 is a Titanium:Sapphire laser source that generates light having an adjustable wavelength range that varies between 710 nm-920 nm. The specific wavelength of the light source 110 is chosen according to the nature of the fluorophores that are suspected, or known to be inside the specimen 104. For example, if the fluorescent lifetime-based analysis is performed to determine if a particular fluorophore known to be excited by incident light of a certain wavelength is present in the specimen, the light source 110 is adjusted to generate light at that wavelength. Other types of light sources, such as a white light source fitted with an optical filter, and/or other types of laser sources generating light at different wavelengths, may also be used.

The optical communication between the light source 110 and the biological specimen 104 is provided by an optical guiding device 112, such as an optical fiber. Other guiding devices, for example an arrangement of mirrors and lenses, can also be used to direct the illuminated light from light source 110 to the biological specimen 104. To illuminate different portions of the specimen 104, and thereby obtain information about the distribution of the fluorophores 102 in different areas of the specimen, the translation stage 106 is moved to displace the specimen 104 relative to the guiding device 112. Alternatively and/or additionally, multiple guiding devices, such as multiple optical fibers, for illuminating the biological specimen 104 at multiple locations may be used.

The optical guiding device 112 is positioned as close as possible to the biological specimen 104 to reduce dispersal of the light incident on the biological specimen 104. In some cases, the guiding device may even abut the specimen 104. Since determination of the location of the fluorophores 102 depends in part on the intensity of light incident on the biological specimen 104, dispersal of the incident light may adversely affect the accuracy of the computed locations and distributions of fluorophores 102 in the biological specimen 104.

The locations of the fluorophores 102 is determined by examining the lifetime of the fluorophores, or in other words, the rate at which the light emitted from excited fluorophores 102 decays. Thus, the light generated by the light source 110 needs to be controlled so that there is no light incident on the biological specimen 104 during the intervals in which the decaying behavior of the fluorophores 102 is examined. The light from light source 110 is controlled by, for example, generating light pulses of fixed durations and examining the excited fluorophores between light pulses. In the apparatus 100 shown in FIG. 1 the light source 110 generates laser pulses of approximately 100 fs (femtosecond) at a repetition rate of 80 MHz. However, different pulse widths at different repetition rates may be used to illuminate the specimen 104.

As further shown in FIG. 1, light source is electrically connected to a delay unit 120. The delay unit 120 controls the timing of a light detection mechanism 138 that in the embodiment of the apparatus 100 shown in FIG. 1, includes a gated intensifier 140 and a Charge-Coupled Device (CCD) camera 146. The delay unit 120 causes light from the excited fluorophores 102 in the specimen 104 to be detected at intervals during which the specimen is not illuminated with the source light. This ensures that the light detection mechanism 138 detects the decaying emitted light from the fluorophores 102. In the embodiment shown, the delay unit 120 activates, in response to a signal from the light source 110, the light detection mechanism a short time interval (e.g., 25 picoseconds) after the light source 110 generates a light pulse.

The delay unit 120 is coupled to a high rate intensifier (HRI) controller 130 that controls the gated intensifier 140. Suitable gated intensifier and/or corresponding controller modules to control such gated intensifiers include those manufactured, for example, by LaVision GmbH. The gated intensifier 140 amplifies the optical signals received from the specimen 104, and passes them to the CCD camera 146. Alternatively, another light capturing device is used. One example of an alternative light capturing device is a photodetector, including an array thereof.

Upon receiving a control signal from the delay unit 120, the HRI controller 130 sends control signals to the gated intensifier 140 that cause a shutter (not shown) connected to the input of the intensifier 140 to open. This permits light emitted from the fluorophores 102 in the specimen 104 to reach the CCD camera 146. Among other things, the HRI controller 130 may control the interval during which the gated intensifier 140 remains open (or active). For example, in some embodiments the gated intensifier 140 remains open for a period in the range of 300-1000 ps (picoseconds). Thus, for fluorophores 102 that are known to have a long lifetime (e.g., 5-10 ns), it may be desirable to keep the shutter of the gated intensifier 140 open for longer to more accurately capture the decay of light emitted by that fluorophore 102.

In some embodiments, the delay unit 120 and/or the HRI controller 130 are configured to collect light from the fluorophores 102. The delay unit 120 and/or HRI controller 130 cause the delay between the end of a laser pulse and the opening of the shutter of the gated intensifier 140 to increase after every laser pulse cycle, thereby enabling the behavior of the fluorophores 102 to be examined at different time instances following the excitation of the fluorophores 102 by the laser pulses. Thus, instead of examining the behavior of excited fluorophores at a single excitation cycle, the behavior of the fluorophores 102 is examined over several cycles of the light source 110 by employing, in effect, a temporal moving window. In other words, the gated intensifier 140 and the CCD camera 146 are configured to examine at every pulse laser cycle a relatively small portion of the lifetime of the fluorophores 102. At every cycle that temporal window is moved by opening the shutter of the gated intensifier 140 at a later time than when the shutter was opened on the preceding cycle. Use of a moving temporal window makes the examination and computation of the fluorophore lifetime and distribution less susceptible to anomalous behavior by the fluorophores 102 during any particular cycle. Additionally, the delay unit 120 and the HRI controller 130 can also be configured to obtain the average behavior of the fluorophores 102 by collecting light over several laser pulse cycles at a particular position of the moving temporal window. That is, the delay between the end of a laser pulse and the opening of the shutter of the gated intensifier 140 remains the same for several cycles. The average intensity of the fluorophore emitted light collected during those laser pulse cycles is then determined.

Prior to being received at the gated intensifier 140, light emitted from the fluorophores 102 in the specimen 104 is first filtered by a bandpass filter 142 tuned to admit only light within the wavelength band at which the light emitted from the fluorophores is expected. For example, if the light source 110 emits 780 nm light and it is known that the fluorophores fluoresce at wavelengths in the 800-840 nm range, a bandpass filter 142 that excludes light outside the 800-840 nm wavelength range is used. In some embodiments a lens 144 focuses light passing through the filter 142 and directs it to an input of the gated intensifier 140. An adjustable aperture on the lens controls the light flux into the gated intensifier 140. In the illustrated embodiment the lens's focal ratio ranges from f/22 to f/1.8. The lens's focal ratio may be adjusted manually or automatically.

Since the light captured by CCD camera 146 is filtered by the bandpass filter 142, the captured light substantially corresponds to light emitted from fluorophores 102 embedded in the biological specimen 104. Such fluorophores can include not only the fluorophores 102 placed in the tissue but also fluorophores that were previously in the biological specimen 104 and/or which naturally occur in the specimen 104.

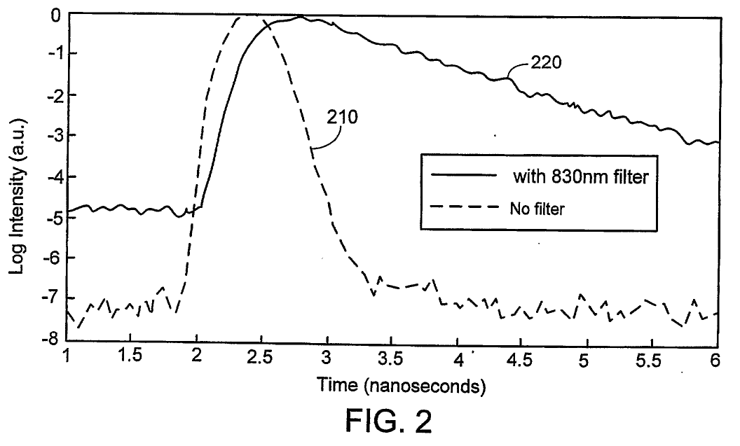

FIG. 2 illustrates the effect of the filter 142 on the time-dependent behavior of light emitted from a specimen 104 as received by a particular pixel of the CCD camera 146. A first curve 210 shows the time-dependent behavior when no filter was used in conjunction with the apparatus 100. A second curve 220 shows the time-dependent behavior when a bandpass filter 142 centered at 830 nm was used. The decay behavior of the fluorophores is clearly shown by the second curve 220.

Returning to FIG. 1, the light detection mechanism 138, as well as any other components of the apparatus 100, are mounted on a mounting assembly 160 to provide it with an unobstructed top view of the specimen 104, and also to provide stability.

The images captured by the CCD camera 146 are subsequently transmitted to computing device 150 that extracts the lifetime data corresponding to the fluorophores 102 from the captured images, and determines the distribution of the fluorophores 102 in the specimen 104. Computing device 150 may include a computer and/or other types of processor-based devices suitable for multiple applications. Such devices can comprise volatile and non-volatile memory elements, and peripheral devices to enable input/output functionality. Such peripheral devices include, for example, a CD-ROM drive and/or floppy drive, or a network connection, for downloading software containing computer instructions to enable general operation of the processor-based device, and for downloading software implementation programs to determine, for example, the identity (e.g., via lifetime behavior analysis) and distribution of fluorophores 102 in the tissue of biological specimen 104.

As further shown in FIG. 1, the computing device 150 is in communication with the delay unit 120 and the HRI controller 130. Communication may be unidirectional, or bidirectional to enable the computing device 150 to receive data (for example, synchronization data) from and to provide control instructions to the delay unit 120 and/or the HRI controller 130. For example, the delay unit 120 may have a programmable delay period that can be controlled by the computing device 150. A user wishing to change the extent of the delay from the time the delay unit 120 receives the trigger pulse signals from the light source 110 to the time that the gated intensifier captures an image may do so by specifying on a user interface supported by the computing device 150 the value of the extent of the delay. The computing device 150 then transmits the delay value to the delay unit 120. Similarly, the shutter opening duration of the gated intensifier 140 may be controlled by sending instructions to the HRI controller 130 from the computing device 150 that specify the shutter opening duration.

It will be understood that the computing device 150 may be dedicated exclusively to determining the identity and distribution of fluorophores 102 in the specimen 104, while other computing devices control the other modules comprising apparatus 100.

### B. Determination of the Fluorophore Distribution and Lifetime

Having recorded the time-dependent behavior of the fluorophores 102 in the specimen 104 at a particular pixel location r_{d} of the CCD camera 146, the time-dependent (i.e., lifetime) behavior of each of the fluorophores 102, as well as the distribution yield, ηₙ(r), of each of the fluorophores 102 (where n is an index representing a particular fluorophore species contributing to the aggregate time-dependent behavior shown, for example, in FIG. 2), may next be determined.

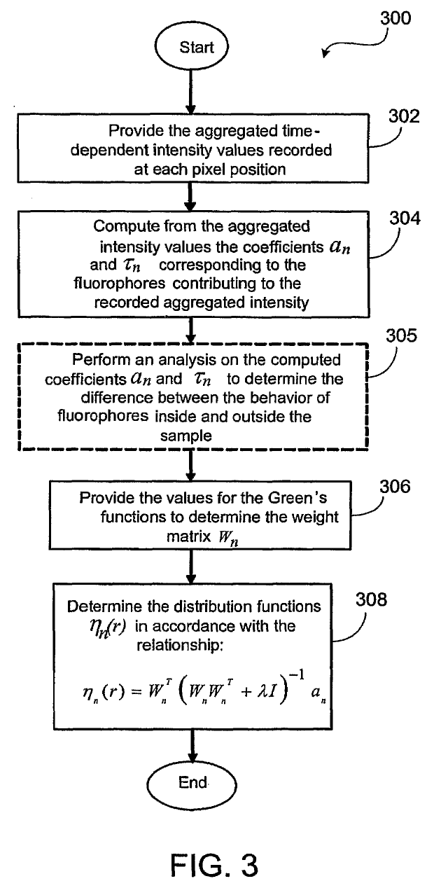

FIG. 3 is a flow chart of an embodiment of a procedure 300 for determining the distribution ηₙ(r) for each of the fluorophores 102 in the specimen 104. For a particular position of the translation stage 106 (and thus for a particular source position rₛ), the aggregated time-dependent intensity values recorded at each pixel position r_{d} corresponding to the emitted light of the fluorophores 102, are provided to a computing device, such as computing device 150 (step 302). The lifetime decay of each fluorophore contributing to the aggregated intensity level at a pixel position r_{d} is described mathematically as:

$${U}_{n} ( {r}_{d} , {r}_{s} , t ) = {a}_{n} ( {r}_{d} , {r}_{s} ) {e}^{- ( \frac{t}{{τ}_{n}} )} \qquad ( 1 )$$

where Uₙ(r_{d},rₛ,t) is the intensity of light emitted by fluorophore species n and detected at pixel r_{d} and time t in response to excitation that was excited by a point source located at position rₛ. The coefficient aₙ(r_{d},rₛ) is the decay amplitude of the light emitted by particular fluorophore species n as measured for a particular source-detector pair (r_{d},rₛ), and τₙ is the lifetime period for the particular fluorophore species (for the sake of brevity, the coefficients aₙ(r_{d},rₛ) will hereinafter be denoted as aₙ.)

The data provided to computing device 150, which corresponds to the intensity level U_{F}(r_{d},rₛ,t) aggregated over all fluorophores can thus be used to compute the various coefficients aₙ and τₙ values for each of fluorophores 102 contributing to the recorded aggregated intensity (step 304). This is achieved by fitting exponential curves corresponding to the various sets of aₙ and τₙ. Computations of the various parameters aₙ and τₙ are carried out using any one of several known iterative procedures for assigning and adjusting values for aₙ and τₙ to minimize a particular error metric. An example of such an iterative procedure is the least-square error procedure. Other types of curve-fitting techniques may be used. Depending on the accuracy desired and the computation complexity tolerated, different subsets of the raw data are used in the computation procedure.

The coefficients aₙ and τₙ correspond to the decaying sections of the curves representative of the light excitation behavior of fluorophore for a source-detector pair (r_{d},rₛ). As such, computation of the coefficients aₙ and τₙ is based on data extracted from the decaying sections of the curves associated with the various source-detector pairs (r_{d},rₛ). Under some circumstances it is not necessary to use all the data recorded for each source-detector pair to determine the distribution of a fluorophore species n in the sample, in part because some of the data may be redundant. Thus, under some circumstances, a single curve may be computed for a group of source-detector pairs. For example, instead of computing the coefficients an for each curve at a particular detector point (e.g., at a particular pixel of the detector), a single coefficient aₙ that is representative of the data recorded at a cluster of detector pixel may instead be determined. Such an approach reduces the volume of computation and expedites the performance of the coefficient computation procedure.

In general, the time dependent light intensity level U_{F}(r_{d},rₛ,t) includes contributions both from the emitted light of excited fluorophore 102, which typically dominates if the delay unit 120 is set to have a large delay, and from stray incident light that diffuses through the medium (e.g., the tissue in which fluorophores are embedded) and through the filter 142. The stray incident light typically may contribute significantly to the value of U_{F}(r_{d},rₛ,t) during the interval the laser pulse is on, and shortly thereafter. It can be shown that when the lifetime of the fluorophore is longer than the timescale associated with the medium absorption coefficient, defined by (vμₐ)⁻¹ (for a heterogeneous sample with spatially varying absorption, the smallest value of μₐ should be chosen to calculate this timescale), substantially the entire contribution to the detected light intensity at the gated intensifier 140 and/or the CCD camera 146 comes from the emitted light of the excited fluorophores irrespective of the thickness, or other parameters, of the medium. It should be noted that this feature holds true provided the light detection interval is longer than the laser pulse intervals. The section entitled Integration of Fluorophores Contributions, provided herein, describes in more detail the circumstances under which the detected light at the gated intensifier 140 and/or the CCD camera 146 substantially corresponds to contributions from the emitted light of the excited fluorophores.

The determination of the coefficients aₙ and τₙ does not require a priori information about the nature of the fluorophore introduced into the sample (e.g., the lifetime characteristics of the fluorophores.) Rather, the procedure described above with respect to 304 enables such information to be extracted based on the measured data for the various source-detector pairs. Optionally, subsequent to completion of the coefficient computation procedure, an analysis of the computed results of the coefficients aₙ and τₙ may be performed at 305 to determine, for example, tissue composition of the sample, based on the difference between the coefficients τₙ computed for fluorophores species introduced into the sample and the corresponding known intrinsic lifetime values of those fluorophores when such fluorophores are excited externally to the sample. In particular, because the lifetime behavior of fluorophores when they interact, or bond, with certain targets (e.g., tissue abnormality or tumor, or even different types of sample tissues) is different from their known intrinsic lifetime behavior when they are examined in isolation from any molecules, an examination of the difference between the decay behavior of fluorophore outside the sample and inside the sample could be indicative of the type of tissues present in the vicinity of the fluorophores within the sample. For example, this type of analysis can provide information about the presence of cancerous tissue or other types of diseased tissue in the analyzed sample. Comparison of the difference between the lifetime values of fluorophores may be performed automatically, using, for example, the computing device 150, or it may be performed manually.

The computed amplitude coefficients aₙ and lifetime period τₙ are further used to compute the 3-D distribution ηₙ(r) for each of the fluorophores 102 in the sample. Specifically, the decay of light emitted by the n^{th} fluorophore species, located at position r and whose light is detected at pixel position r_{d} in response to illumination by a point source at rₛ can be expressed using the following linear relationship:

aₙ(rₛ,r_{d})=Wₙ(rₛ,r_{d},r)ηₙ(r) (2)

where the weight matrix Wₙ is given by

Wₙ(rₛ,r_{d},r)=Gₓ(rₛ,r)Gₘ(r,r_{d}) (3)

with Gₓ and Gₘ denoting continuous wave (CW) Green's functions of the diffusion equation assuming that the medium absorption is uniformly reduced by Γₙ/v (i.e., μₐ(r)→μₐ(r)−Γₙ/v, where v is the velocity of light in the medium).

The Green's function Gₓ(rₛ,r) has the form:

$${G}_{x} ( {r}_{s} , r ) = \frac{1}{4 π {D}_{x} \vert {r}_{s} - r \vert} {e}^{i \sqrt{\frac{- v {μ}_{ax}}{{D}_{x}}} \vert {r}_{s} - r \vert} \qquad ( 4 )$$

where Dₓ=v/(3μₛₓ) corresponds to the diffusion coefficient, and μₐₓ and μₛₓ are the absorption and reduced scattering coefficients, respectively, for the particular medium between the points rₛ and r. Similarly, the Green's function Gₘ(r,r_{d}) can be expressed as:

$${G}_{m} ( {r}_{d} , r ) = \frac{1}{4 π {D}_{m} \vert {r}_{d} - r \vert} {e}^{i \sqrt{\frac{- v {μ}_{am}}{{D}_{m}}} \vert {r}_{d} - r \vert} \qquad ( 5 )$$

where Dₘ=v/(3μₛₘ) corresponds to the diffusion coefficient, and μₐₘ and μₛₘ are the absorption and reduced scattering coefficients, respectively, for the particular medium between the points r_{d} and r. The Green's functions in Equations (4) and (5) correspond to the case where the medium is infinite in extent. For finite sized slab-like geometries, the Green's functions may be evaluated using the well known method of images. Alternatively, for complex boundaries like mice, the Green's functions may be evaluated by solving the diffusion or transport equations with appropriate boundary conditions. Further description of Green's functions is provided in S. R. Arridge's “Optical tomography in medical imaging,” Inverse Problems 15 (1999), R41-R93, the content of which is hereby incorporated by reference in its entirety.

The Green's function Gₓ(rₛ,r) represents the probability that a photon emitted from source point rₛ will reach a particular point r in the medium. That probability is determined in accordance with the absorption and reduced scattering coefficients for the medium, which are known in advance. Accordingly, the numerical values for the function Gₓ(rₛ,r) may be computed for various locations r in the medium being examined, and the computed values may thereafter be stored in, for example, a matrix. Similarly, the Green's function Gₘ(r,r_{d}) represents the probability that a photon located at position r in the medium will reach a pixel at location r_{d}. That probability is likewise determined by using the corresponding absorption and reduced scattering coefficients, which may be the same or different from the coefficients used with respect to the computations of the Green's function Gₓ(rₛ,r).

Thus, at step 306 the numerical values for the Green's functions are provided. Those numerical values are either computed in advance and stored, or are computed during performance of the procedure 300. The weight matrix Wₙ can then be determined using the computed values of the Green's functions.

Having determined the matrix Wₙ, the well known Tichonov regularization procedure is applied to Equation (3) to obtain the distribution ηₙ(r) for each of the species of fluorophores 102 in the specimen 104 (step 308). Specifically:

ηₙ(r)=Wₙ^{T}(WₙWₙ^{T}+λI)⁻¹aₙ (6)

Here the superscript T denotes the matrix transpose operation, and I denotes an identity matrix. The parameter λ is the regularization parameter and is used to optimize the quality of the image reconstruction. In other words, the inversion of Equation (6) is carried out for various values of λ to obtain the best image quality. The weight matrix Wₙ is arranged so that it is of dimension (M×N), where M is the total number of measurements (or source-detector pairs), and N is the total number of medium points, and aₙ is of dimension (M×1). Thus, ηₙ(r) will be of dimension (N×1). The medium points refer to the center of finite sized (typically 0.1 mm³) cubes into which the specimen 104 is partitioned. The small cubes are also referred to as voxels. The partitioning of the specimen 104 into a finite number of voxels thus makes computation of the distribution functions ηₙ(r) more manageable since the computations will involve only a finite set of points r (each corresponding to one voxel). In typical situations, there are 5000-10000 voxels for a mouse sized specimen, and approximately 1000 source and detector combinations. Therefore, in a typical situation where N=5000 and M=1000, the matrix Wₙ will have dimensions of 1 000×5000. Accordingly, ηₙ(r) will be of dimension 5000×1, representing the distribution of the n^{th} fluorophore species across the 5000 medium points of the specimen 104.

Once the distribution ηₙ(r) is determined for each of the fluorophores 102 in the specimen 104, an analysis of the determined distribution data may be performed manually or automatically to identify, for example, possible abnormalities in the tissue of the specimen 104. Additionally, the translation stage 106 may be moved to a different position and the procedure described herein may be performed for a different portion of the specimen 104.

As explained above, the coefficients aₙ and τₙ are typically computed using data from the decaying sections of the time-dependent fluorophore excitation data recorded by the detector device. Consequently, computation of the fluorophore distribution functions ηₙ(r) is based on data corresponding to the decaying sections of the excitation curves. While this approach expedites the computation of the coefficients aₙ and τₙ, computation of the distribution functions ηₙ(r) makes no use of the data corresponding to the rising sections of the time-dependent fluorophore excitation curves.

Thus, another approach for computing the distribution functions ηₙ(r) uses the data corresponding to the rising sections of the curves, and can thereby achieve a higher degree of accuracy in determining the distribution of fluorophores in the medium under investigation.

Specifically, in some embodiments, the coefficients values aₙ and τₙ are first computed in the manner described above with respect to block 304 of FIG. 3, using the data corresponding to the decaying sections of the curves. As noted above, the computed coefficients a, are arranged in an M×1 matrix, where M is the number of source-detector pairs with respect to which fluorophore excitation behavior has been measured. A corresponding weight matrix Wₙ is computed for the same set of source-detector pairs, as more particularly described with respect to blocks 306 and 308 of FIG. 3, using Green's functions. The weight matrix Wₙ is of dimension M×N.

Inclusion of data corresponding to the rising sections of the curves representative of the fluorophores' light excitation behavior is performed by augmenting the M×1 coefficient matrix aₙ with data points from the rising sections of at least some of the curves used to determine the distribution functions ηₙ(r). For example, if M is 5000 (i.e., there are 5000 coefficients a, corresponding to 5000 source-detector pair curves), and a single raw data point from the rising section of each source-detector pair curve is used, then the data matrix used for the inversion will expand to a size of 10,000 entries, with 5000 entries corresponding to determined a, coefficients, and 5000 entries corresponding to actual raw data from the rising sections of the curves. In some embodiments 2-3 time points per source-detector pair measurements may be sufficient for a suitable balance between computational requirements and the reconstruction quality (e.g., the accuracy of the resultant distribution functions for the fluorophores.) Accordingly, for an initial aₙ coefficient matrix having an initial size of 5000×1, the inclusion of two (2) time point data from the rising sections of each source-detector measurement curves will result in a modified data matrix having a size of 1 5,000×1.

Having modified the matrix aₙ, the weight matrix Wₙ needs to be correspondingly modified. In particular, a time domain generalization of the weight matrix W̅ₙ provided in Equation (3) is as follows:

Wₙ(rₛ,r_{d},r,t)=Gₓ(rₛ,r,t) [symbol] Gₘ(rₛ,r_{d},t) (7)

where Gₓ(rₛ,r,t) and Gₘ(r,r_{d},t) are the time domain Green's functions evaluated with the background absorption of the medium at the excitation and emission wavelengths reduced uniformly by the constant Γₙ/v. For a medium of infinite extent the time domain Greens functions are given by:

$${G}_{x} ( {r}_{s} , r , t ) = \frac{1}{{( 4 π {D}_{x} t )}^{3 / 2}} exp [ - \frac{{( r - {r}_{s} )}^{2}}{4 {D}_{x} t} - v {μ}_{ax} t ] ;$$

$${G}_{m} ( r , {r}_{d} , t ) = \frac{1}{{( 4 π {D}_{m} t )}^{3 / 2}} exp [ - \frac{{( r - {r}_{d} )}^{2}}{4 {D}_{m} t} - v {μ}_{am} t ]$$

As in the case of the continuous wave Greens functions Equations (4) and (5), generalization to finite sized media can be made using the method of images or by solving the finite boundary diffusion or transport equations.

These quantities can be used to provide a generalized form of Equation (2), which incorporates the early time portion of the data (i.e., the data corresponding to the rise sections):

$$( \begin{matrix}{U}_{F} ( {t}_{1} ) \\ ⋮ \\ ⋮ \\ {a}_{n} \\ {a}_{n + 1} \\ ⋮ \\ ⋮\end{matrix} ) = ( \begin{matrix}⋮ & {\overline{W}}_{n} ( {t}_{1} ) & {\overline{W}}_{n + 1} ( {t}_{1} ) & ⋮ \\ ⋮ & ⋮ & ⋮ & ⋮ \\ ⋮ & ⋮ & ⋮ & ⋮ \\ ⋮ & {W}_{n} & 0 & ⋮ \\ ⋮ & 0 & {W}_{n + 1} & ⋮ \\ ⋮ & ⋮ & & ⋮ \\ ⋮ & ⋮ & ⋮ & ⋮\end{matrix} ) ( \begin{matrix}⋮ \\ {η}_{n} \\ {η}_{n + 1} \\ ⋮\end{matrix} ) \qquad ( 8 )$$

In the above equation U_{F}(t₁) refers to the data at a time point t₁ in the rising portion of the temporal response curve in FIG. 2. Thus the time domain weight function W̅ₙ is also evaluated at the corresponding time point. As noted above, typically 2-3 time points per source-detector measurements may be sufficient to achieve a suitable balance between computational requirements and image reconstruction quality. As can be seen from Equation (8), the weight matrix is populated with terms that are time-dependent (e.g., Wₙ(t₁)) and terms that are not time-dependent (e.g., Wₙ.) The non-time-dependent terms are computed in accordance with, for example, Equations (3)-(5), and as such depend on spatial locations of the source, detector, and the sample. The time-dependent terms, on the other hand, are computed in accordance with Equation (7), and as such the resultant weight coefficients also have a temporal dependency as well.

If Equation (8) is expressed as a linear matrix equation (i.e., y=Wx,) inverting this linear equation results in the relationship:

x=W^{T}(WW^{T}+λI)⁻¹y (9)

The column matrix x is thus the final result containing the yield reconstructions of the individual lifetime components ηₙ obtained by utilizing the decay sections, as well as the early rise sections of the temporal data measured for the various source-detector pairs.

Other approaches for incorporating data corresponding to, for example, the rising sections of the various source-pair measurements, may be used to perform the computation of the distribution functions ηₙ(r). Such approaches generally require a greater use of computation resources (e.g., memory and computational time/speed). Thus, the extent to which available data is used to compute the distribution functions ηₙ(r) will depend on maintaining a balance between computing resource utilization and result accuracy.

### Implementation

The methods and systems described herein are not limited to a particular hardware or software configuration, and may find applicability in many computing or processing environments. The methods and systems can be implemented in hardware, or a combination of hardware and software, and/or can be implemented from commercially available modules applications and devices. Where the implementation of the systems and methods described herein is at least partly based on use of microprocessors, the methods and systems can be implemented in one or more computer programs, where a computer program can be understood to include one or more processor executable instructions. The computer program(s) can execute on one or more programmable processors, and can be stored on one or more storage medium readable by the processor (including volatile and non-volatile memory and/or storage elements), one or more input devices, and/or one or more output devices. The processor thus can access one or more input devices to obtain input data, and can access one or more output devices to communicate output data. The input and/or output devices can include one or more of the following: Random Access Memory (RAM), Redundant Array of Independent Disks (RAID), floppy drive, CD, DVD, magnetic disk, internal hard drive, external hard drive, memory stick, or other storage device capable of being accessed by a processor as provided herein, where such aforementioned examples are not exhaustive, and are for illustration and not limitation.

The computer program(s) can be implemented using one or more high level procedural or object-oriented programming languages to communicate with a computer system; however, the program(s) can be implemented in assembly or machine language, if desired. The language can be compiled or interpreted. The device(s) or computer systems that integrate with the processor(s) can include, for example, a personal computer(s), workstation (e.g., Sun, HP), personal digital assistant (PDA), handheld device such as cellular telephone, laptop, handheld, or another device capable of being integrated with a processor(s) that can operate as provided herein. Accordingly, the devices provided herein are not exhaustive and are provided for illustration and not limitation.

References to “a microprocessor”, “a processor,” and “a processor-based machine,” or “the microprocessor,” “the processor,” and “a processor-based machine” and can be understood to include one or more microprocessors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network using a variety of communications protocols, and unless otherwise specified, can be arranged to include a combination of external and internal memory devices, where such memory can be contiguous and/or partitioned based on the application. Accordingly, references to a database can be understood to include one or more memory associations, where such references can include commercially available database products (e.g., SQL, Informix, Oracle) and also proprietary databases, and may also include other structures for associating memory such as links, queues, graphs, trees, with such structures provided for illustration and not limitation.

### EXAMPLES

The following are non-limiting examples provided for illustration.

### Example 1

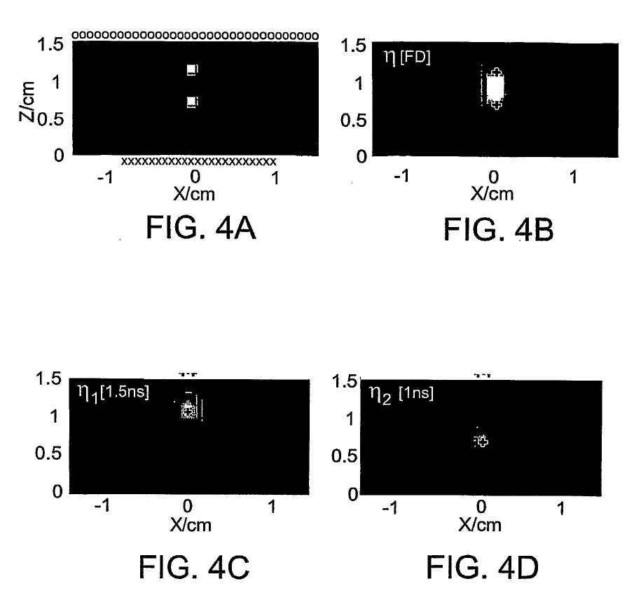

FIGS. 4A-D show simulation results for determining the distribution of fluorophores in a homogeneous slab. Specifically, the behavior of two fluorophores having the same yield (i.e., the fluorophores' ability to emit light) but distinct lifetimes of ins and 1.5 ns, respectively, was determined using 3-D fluorescence data generated using a Monte-Carlo simulation procedure. The slab used in the simulation was a 1.5 cm thick slab, with scattering coefficient μₛ=10/cm, and an absorption coefficient μₐ=0.1/cm. The reduced scattering coefficient represents the expected number of scattering events that a photon undergoes when it travels 1 centimeter through the medium. A scattering event is defined as the deflection of the photon from its normal path. The absorption coefficient represents the expected number of absorption events that a photon undergoes when it travels 1 centimeter through the medium. An absorption event is defined as the probability that a photon will be completely removed from its path.

An illustration of the simulated setup is shown in FIG. 4A. As also shown in FIG. 4A, the positions of the detector's pixels are represented by the symbol “o”, whereas the positions of the point sources are represented by “x”. Although several point sources are shown in FIG. 4A, as was previously explained, the actual apparatus may comprise a single point source whose position relative to the specimen may be changed by translating the specimen relative to the point source. Simulation of the detection of emitted light from the fluorophores used in the simulated setup was based on the probabilities of detecting an emitted photon given the absorption and scattering coefficient used in this setup.

The simulated data corresponding to the two fluorophores was then processed using a conventional frequency domain analysis and the time-domain lifetime approach described herein. The frequency domain analysis included passing frequency modulated light through the medium, followed by a detection of the intensity and phase of the light. This information was used to reconstruct the fluorescence yield and lifetime as distributions. FIG. 4B shows an x-z slice of the computed fluorophore distribution in the simulated slab when the data was processed using the frequency-domain procedure. FIGS. 4C-4D show the computed distribution for each of the fluorophores when the fluorescence lifetime-based procedure described herein was used to analyze the simulated data. The “+” symbols in FIGS. 4B-D indicate the true fluorophore locations. As can be seen from FIG. 4B, the identity and distribution of the individual fluorophores cannot be discerned using the conventional frequency-domain procedure. In contrast, FIGS. 4C-D provide more accurate data regarding the identity and distribution of the individual fluorophores used in the simulation.

### Example 2

To further demonstrate the efficacy of the fluorescence lifetime-based procedure described herein, the following experiment was conducted. A near-infrared dye from Li-Cor Biosciences, with absorption and emission maxima of approximately 770 nm and 790 nm, respectively, was used. Two polypropylene tubes were placed with a 4.5 mm vertical separation in a Petri dish. In one tube, the dye was mixed in an aqueous solvent, while in the other tube the dye was mixed with a glycerol solvent. The two different solvents used with the respective tubes resulted in two fluorophores having different lifetimes. The Petri dish was filled with intra-lipid solution. The tubes were illuminated with a Spectra-Physics Titanium:Sapphire laser source having a 200 fs pulse width, 80 MHz repetition rate, and a tunable wavelength range of 710 nm-920 nm. The resultant emitted light from the tubes was captured using a gated intensified CCD camera, having a 500 ps gate width, from LaVision GmbH. The full temporal fluorescence signal was collected at 830 nm using a bandpass filter for a line of 41 source-detector combinations placed 1 mm apart across the tube. The lifetimes for the fluorophores were determined to be 0.5 ns and 0.8 ns, respectively, by performing a non-linear fit to that subset of the captured image data that produced the best signal-to-noise ratio (SNR).

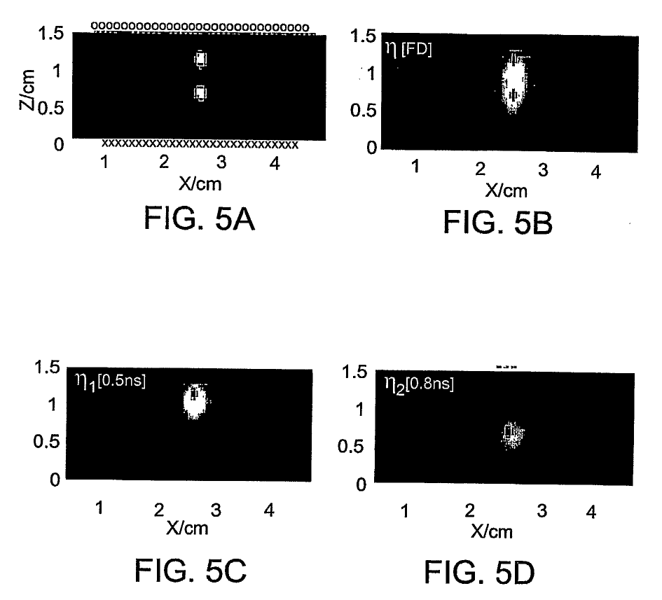

FIG. 5A shows the setup used for the experiment, including the location of the two tubes that were filled with the dye. FIG. 5B shows the graphical representation of the fluorescence yield when a frequency-domain-based procedure, similar to the one used with respect to the simulation results of FIG. 4B, was performed. As can be seen from FIG. 5B, the fluorophore distribution in the two tubes cannot be discerned accurately. On the other hand, as can be seen in FIGS. 5C-D, which show the graphical representation of the distributions for the two fluorophores when the fluorescence lifetime-based procedure was employed, the separation of the tubes, each containing a fluorophore having a different lifetime, is visible.

### Integration of Fluorophores Contribution

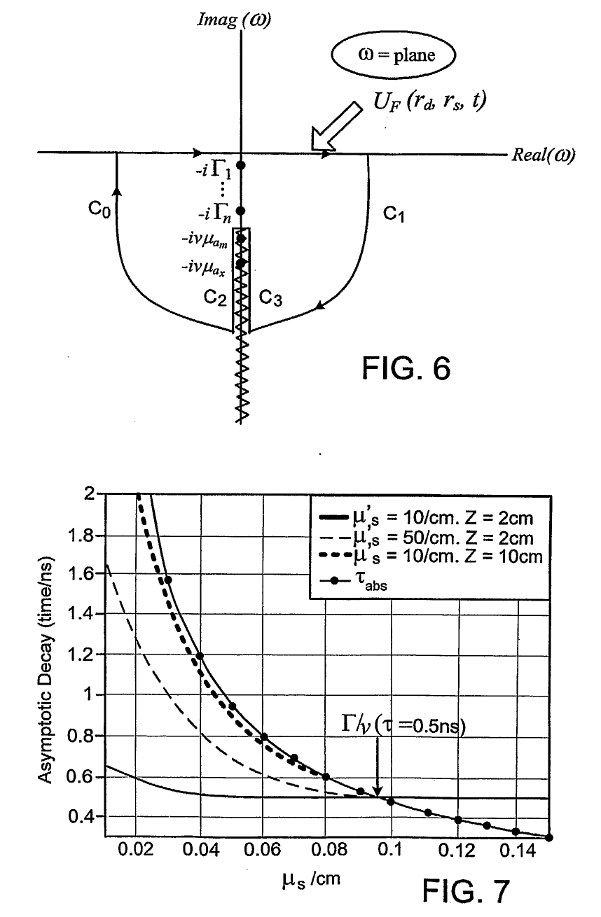

To appreciate the nature of the time-resolved fluorescence signal from diffuse media, it is useful to start from the Fourier transform of the frequency domain counterpart written in its adjoint form. The lifetime analysis performed on the fluorophores within the biological medium of interest provides the fluorescence yield distributions ηₙ(r) with corresponding lifetimes τₙ=1/Γₙ. The detected fluorescence intensity at position r_{d} and time t due to excitation by a point source at rₛ and at time t=0 is then provided by the Born approximation, which considers a single fluorophore absorption and emission event as (omitting scaling coefficients for simplicity):

$${U}_{F} ( {r}_{d} , {r}_{s} , t ) = {\sum }_{n} {\int }_{- ∞}^{∞} d {ωe}^{- iω t} {\int }_{V} {d}^{3} r [ {\tilde{G}}_{m} ( {r}_{d} , {r}_{s} , ω ) \frac{{iΓ}_{n} {η}_{n} ( r )}{ω + {iΓ}_{n}} {\tilde{Φ}}_{x} ( r , {r}_{s} , ω ) ] \qquad ( A )$$

where Φₓ(r,rₛ,ω) and Gₘ(r_{d},r,ω) are the Green's function and fluence for the excitation light from a point source to the fluorophore and emission from the fluorophore to the detector respectively, and the volume integration is over the extent of the medium. The analytic nature (in the complex variable sense) of the integrand in Equation (A) is examined using the Green's functions for an infinite homogeneous medium, which are of the form exp(ik_{x,m}r)/4πD_{x.m} with k²_{x,m}=(−vμ_{ax,m}+iω))/D_{x,m}(=v/3μ′_{s,x,m}) and μ′_{s,x,m} denote, respectively, the absorption, diffusion and reduced scattering coefficients, and v is the velocity of light in the medium. The homogenous Green's function and its spatial derivatives are bi-valued owing to the square root in k, implying branch points in the lower half plane at ω=−ivμₐₓ, −ivμₐₘ. In addition, the integrand in Equation (A) possesses simple pole singularities distributed along the negative imaginary axis at ωₙ=−i/Γₙ. FIG. 6 shows the complex plane spectrum of the integrand in Equation (A) and a possible contour for evaluating the integral. As seen in FIG. 6, the contour for evaluating the integral of Equation (A) includes the arcs C₀ and C₁ in the lower half plane, line integrals C₂ and C₃ that run along the branch cut, and the integral over the real axis that evaluates U_{F}. Also shown in FIG. 6 is the branch cut extending from −vμₐₘ to −∞, and the simple poles located at −iΓₙ, for the case vμₐ<Γₙ.

On applying Cauchy's integral theorem to this contour, U_{F}(r_{d},rₛ,t) separates into two parts, the first corresponding to fluorescence decay terms (arising from the residue at the simple poles) and the other corresponding to a diffuse photon density wave (arising from the integration on either side of the branch cut):

$${U}_{F} ( {r}_{d} , {r}_{s} , t ) = {\sum }_{n} {a}_{{F}_{n}} ( {r}_{d} , {r}_{s} ) {e}^{[ - {Γ}_{n} i ]} + {a}_{D} ( {r}_{d} , {r}_{s} t ) {e}^{[ - v {μ}_{a} t ]} \qquad ( B )$$

where the absorption coefficient are set μₐ=μ_{a,x}=μ_{a,m}, without any loss of generality. The amplitude a_{Fn} of the decay of the n-th fluorophore is the residue at the simple pole at −i/Γₙ, and is in the form of a linear inverse problem for the yield distribution ηₙ(r) of the n-th fluorophore:

a_{F}_{ₙ}(r_{d},rₛ)=∫_{V}d³rWₙ(rₛ,r_{d},r)ηₙ(r) (C)

where the weight matrix for the inversion is given by:

Wₙ=Γₙ\tilde{G}ₘ(r_{d},r,ω=iΓₙ)\tilde{Φ}ₓ(r,rₛ,ω=iΓₙ) (D)
The coefficient a_{D} (second term in Equation (B)) is calculated as the contribution from the branch points and takes the following highly non-exponential form (for vμₐ>Γₙ, ∀ₙ):

$${a}_{D} ( {r}_{D} , {r}_{s} , t ) = {\sum }_{n} \frac{v {Γ}_{n}}{8 {π}^{2} {D}^{2}} {\int }_{0}^{∞} d {γe}^{- γ t} {\int }_{V} {d}^{3} r \frac{{η}_{n} ( r ) sin [ ( {ρ}_{sr} + {ρ}_{dr} ) \sqrt{γ / D} ]}{{ρ}_{sr} {ρ}_{dr} ( γ + v {μ}_{a} - {Γ}_{n} )} \qquad ( E )$$

where ρₛᵣ=|rₛ−r| and ρ_{dr}=|rₛ−r|. The amplitudes for the case when Γₙ>vμₐ can also be similarly evaluated. It should be noted that in the limit of instantaneous emission, a_{D} reduces to an analytical form for the temporal diffusion signal in the Born approximation from absorbing “perturbations” ηₙ(r). The above results were derived assuming a homogeneous infinite medium. But since a general solution for the inhomogeneous diffusion equation in a bounded volume may be written in terms of the homogeneous Green's function and its normal derivatives at the boundary, it is plausible to assert that the complex plane structure of the integrand in Equation (A) is reproduced for arbitrary inhomogeneous media. This implies that Equation (D), which results from the contribution of the simple poles, can be generalized to arbitrary media by simply substituting the Greens function solutions of the heterogeneous diffusion equation with finite boundary models.

The inverse problem as expressed in Equations (C) and (D) and the subsequent generalization to arbitrary media enables the localization of multiple fluorophores from a lifetime analysis of asymptotic fluorescence decays. However, in order for these equations to be applicable to imaging in the presence of turbid tissue, it is necessary to determine the conditions when the first term of Equation (B) is the dominant contribution to the total signal, or equivalently, when the decay times of the measured signal are governed purely by the fluorescence lifetimes. The decay time of time resolved signals is affected by diffuse propagation effects for strongly scattering and weakly absorbing tissue, and for short intrinsic fluorophore lifetimes. Review of Equation (B) suggests that when the absorption time scale τ_{abs}(=(vμₐ)⁻¹<Γₙ⁻¹, the asymptotic behavior is primarily governed by the fluorescence decay. FIG. 7 shows the decay time of simulated fluorescence signals for a range of optical properties (μₐ, μ′ₛ), assuming a slab diffusion model. It is clear from FIG. 7 that the influence of the absorption on the asymptotic decay time is related to the value of the scattering coefficient, with the absorption having a stronger effect for larger μ′ₛ and Z. Also, an increase in medium thickness has a more pronounced effect on lifetime than a corresponding increase in scattering (maintaining the product μ′ₛL<50 cm⁻¹), and thus the fluorescence lifetime can be extracted from the asymptotic tail of the TD signal provided the lifetimes satisfy the condition τₙ>τ_{abs} (for heterogeneous media, Tabs should be evaluated for the smallest absorption present in the medium). It is to be noted from the case of Z=2, μ′ₛ=10/cm shown in FIG. 7 that the lifetime is recovered asymptotically even when τ_{abs} is much larger than the fluorophore lifetime of 0.5 ns, indicating that the condition τₙ>τ_{abs} is relaxed for short propagation lengths.

### OTHER EMBODIMENTS

A number of embodiments of the invention have been described. Nevertheless, it will be understood that various modifications may be made without departing from the spirit and scope of the invention. Accordingly, other embodiments are within the scope of the following claims.

What is claimed is:

1. A method for determining a distribution of fluorophores embedded in a sample, the method comprising:
placing fluorophores into the sample,
illuminating the sample with light selected to excite the fluorophores,
detecting emitted light from the excited fluorophores, and
performing a time-domain analysis on the detected emitted light to determine a three-dimensional distribution of the fluorophores in the sample.

2. The method of claim 1, wherein performing a time-domain analysis to determine the three-dimensional distribution comprises:
extracting lifetime data corresponding to the excited fluorophores from the detected emitted light,
computing, from the extracted data, corresponding amplitude coefficients, an, representative of initial amplitudes of the emitted light, and
computing, at points r in the specimen, a distribution function, ηₙ(r) based at least in part on the basis of the amplitude coefficients aₙ.

3. The method of claim 2, wherein the lifetime data includes time-dependent data representative of time-dependent fluorophore excitation behavior, wherein the time-dependent data corresponding to time-dependent curves, each time-dependent curve having a rising section and a decaying section, and wherein computing the amplitude coefficients aₙ includes determining a value of the amplitude coefficients based at least in part on data representing a decaying section of a time-dependent curve.

4. The method of claim 3, wherein computing, at points r in the specimen, a value of distribution function ηₙ(r) comprises computing the value based at least in part on data corresponding to a rising section of a time-dependent curve.

5. The method of claim 2, wherein computing the amplitude coefficients aₙ comprises applying a curve-fitting technique to the lifetime data.

6. The method of claim 2, wherein computing a value of the distribution function ηₙ(r) comprises obtaining a pre-determined weight matrix, Wₙ, based at least in part on a Green's function associated with the sample.

7. The method of claim 6, wherein the lifetime data includes time-dependent data representative of time-dependent fluorophore excitation behavior, wherein the time-dependent data corresponds to time-dependent curves, each time-dependent curve having a rising section and a decaying section, and wherein obtaining a predetermined weight matrix Wₙ is further performed based on data corresponding to the rising sections of the respective curves.

8. The method of claim 1, wherein detecting emitted light from the excited fluorophores comprises:
intensifying light emitted by the excited fluorophores, and
capturing the intensified light at a light detection device.

9. The method of claim 8, wherein capturing the intensified light comprises illuminating a Charge-Coupled Device (CCD) array.

10. The method of claim 1, wherein the sample has absorption coefficients μₐ such that the fluorophore lifetimes are longer than an intrinsic absorption time scale defined by (vμₐ)⁻¹.

11. An apparatus for determining a distribution of fluorophores embedded in a sample, the apparatus comprising:
a light source configured to illuminate the sample with light selected to excite the fluorophores,
a light detection device configured to detect light emitted by the excited fluorophores, and
a processing module configured to determine, based on a time-domain analysis performed on the detected light, a three-dimensional distribution of the fluorophores in the sample.

12. The apparatus of claim 11, wherein the processing module is further configured to:
extract lifetime data corresponding to the excited fluorophores from the detected emitted light,
compute, from the extracted data, corresponding amplitude coefficients, an, representative of initial amplitudes of the emitted light, and
compute, at points r in the sample, a distribution function ηₙ(r) based at least in part on the amplitude coefficients aₙ,

13. The apparatus of claim 12, wherein the lifetime data includes time-dependent data representative of time-dependent fluorophore excitation behavior, wherein the time-dependent data correspond to time-dependent curves, each time-dependent curve having a rising section and a decaying section, and wherein the processing module configured to compute the amplitude coefficients a, is further configured to determine a value of the amplitude coefficients based at least in part on data representing a decaying section of a time-dependent curve.

14. The apparatus of claim 13, wherein the processing module configured to compute, at points r in the specimen, a value of distribution function ηₙ(r) is further configured to compute a value based at least in part on data corresponding to a rising section of a time-dependent curve.

15. The apparatus of claim 12, wherein the processing module configured to compute the amplitude coefficients aₙ is further configured to apply a curve-fitting technique to the lifetime data.

16. The apparatus of claim 12, wherein the processing module is configured to compute the distribution function ηₙ(r) by obtaining a weight matrix Wₙ based at least in part on a Green's function associated with the sample.

17. The apparatus of claim 16, wherein the data includes time-dependent data representative of time-dependent fluorophore excitation behavior, wherein the time-dependent data corresponds to time-dependent curves, each time-dependent curve having a rising section and a decaying section, and wherein the processing module configured to obtain a pre-determined weight matrix Wₙ is further configured to obtain weight matrix Wₙ based on data corresponding to the rising sections of the respective curves.

18. The apparatus of claim 11, wherein the light detection device comprises:
an intensifier module in optical communication with the sample, wherein the intensifier module is configured to intensify the light emitted from the excited fluorophores, and
wherein the light detection device is disposed to capture intensified light from the intensifier module.

19. The apparatus of claim 18, wherein the light detection device includes a Charge-Coupled Device (CCD) array.

20. The apparatus of claim 11, wherein the sample has absorption coefficients μₐ such that the fluorophore lifetimes are longer than an intrinsic absorption time scale defined by (vμₐ)⁻¹.

21. A computer program product for determining a distribution of fluorophores embedded in a sample, the computer program product residing on a machine-readable medium for storing computer instructions that, when executed, cause a processor-based machine to:
receive data corresponding to detected light emitted from the fluorophores placed in the sample when the fluorophores are excited by illuminated light; and
perform a time-domain analysis on the detected emitted light to determine a three-dimensional distribution of the fluorophores in the sample.

22. The computer program product of claim 21, wherein the computer instruction that cause the processor-based machine to perform a time-domain analysis to determine the three-dimensional distribution comprise instructions that cause the processor-based machine to:
extract lifetime data corresponding to the excited fluorophores from the detected emitted light,
compute, from the extracted data corresponding amplitude coefficients, aₙ, representative of initial amplitudes of the emitted light, and
compute, at points r in the specimen, a distribution function ηₙ(r) based at least in part on the amplitude coefficients aₙ.

23. The computer program product of claim 22, wherein the lifetime data includes time-dependent data indicative of time-dependent fluorophore excitation behavior, wherein the time-dependent data corresponds to time-dependent curves, each curve having a rising section and a decaying section, and wherein the computer instructions that cause a processor-based machine to compute the amplitude coefficients aₙ include computer instructions that cause the processor-based machine to determine the value of the amplitude coefficients based at least in part on data representing a decaying section of a time-dependent curve.

24. The computer program product of claim 23, wherein the computer instructions that cause the processor-based machine to compute, at points r in the specimen, a value of distribution function ηₙ(r) comprise computer instructions that cause the processor-based machine to compute a value based at least in part on data corresponding to a rising section of a time-dependent curve.

25. The computer program product of claim 22, wherein the computer instructions that cause the processor-based machine to compute the amplitude coefficients aₙ comprise computer instructions that cause the processor-based machine to apply a curve-fitting technique to the lifetime data.

26. The computer program product of claim 22, wherein the computer instructions that cause the processor-based machine to compute the value of the distribution function ηₙ(r) comprise computer instructions that cause the processor-based machine to obtain a pre-determined weight matrix Wₙ based at least in part on a Green's function associated with the sample.

27. The computer program product of claim 26, wherein the data includes data representative of time-dependent fluorophore excitation behavior, wherein the time-dependent data corresponds to time-dependent curves, each time-dependent curve having a rising section and a decaying section, and wherein the computer instructions that cause the processor-based machine to obtain a pre-determined weight matrix Wₙ further cause the processor-based machine to obtain the weight matrix based on data corresponding to rising sections of the respective curves.

28. The computer program product of claim 21, wherein the sample has absorption coefficients μₐ such that the fluorophore lifetimes are longer than the intrinsic absorption time scale defined by (vμₐ)⁻¹.

29. A method for determining lifetimes of fluorophores embedded in a sample comprising one or more tissue types, the method comprising:
placing fluorophores having associated known intrinsic lifetimes into the sample,
illuminating the sample with light selected to excite the fluorophores,
detecting emitted light from the excited fluorophores,
extracting lifetime data corresponding to the excited fluorophores from the detected emitted light,
computing, from the extracted data, corresponding lifetimes τₙ representative of a decay time associated with the fluorophores when placed in the sample, and
identifying at least one of the tissue types based on difference between the computed lifetimes τₙ with the fluorophores in the sample and corresponding intrinsic lifetimes of the fluorophores.

30. The method of claim 29, wherein detecting emitted light from the excited fluorophores comprises:
intensifying light emitted by the fluorophores, and
capturing the intensified light at a light detection device.

31. The method of claim 30, wherein capturing the light comprises illuminating a Charge-Coupled Device CCD array.

32. The method of claim 29, wherein the sample has an absorption coefficients μₐ such that the fluorophore lifetimes are longer than an intrinsic absorption time scale defined by (vμₐ)⁻¹.

33. An apparatus for determining lifetimes of fluorophores embedded in a sample comprising one or more tissue types, the fluorophores having associated known intrinsic lifetimes, the apparatus comprising:
a light source configured to illuminate the sample with light selected to excite the fluorophores,
a light detection device configured to detect light emitted by the excited fluorophores, and
a processing module configured to:
extract lifetime data corresponding to the excited fluorophores from the detected emitted light,
compute, from the extracted data, corresponding lifetimes τₙ representative of a decay time associated with the fluorophores when placed in the sample, and
identify at least one of the tissue types based on a difference between the computed coefficients τₙ and corresponding intrinsic lifetimes of the fluorophores.

34. The apparatus of claim 33, wherein the light detection device comprises:
an intensifier module in optical communication with the sample, wherein the intensifier module is configured to intensify the light received from the excited fluorophores, and
a light detection device disposed to capture intensified light from the intensifier module.

35. The apparatus of claim 34, wherein the light detection device includes a Charge-Coupled Device (CCD) array.

36. The apparatus of claim 33, wherein the sample has an absorption coefficients μₐ such that the fluorophore lifetimes are longer than an intrinsic absorption time scale defined by (vμₐ)⁻¹.

37. A computer program product for determining lifetime of fluorophores embedded in a sample comprising one or more tissue types, the fluorophores having associated known intrinsic lifetimes, the computer program product residing on a machine-readable medium for storing computer instructions that, when executed, cause a processor-based machine to:
receive data corresponding to detected light emitted from the fluorophores placed in the sample when the fluorophores are excited by illuminated light;
extract lifetime data corresponding to the excited fluorophores from the detected emitted light,
compute, from the extracted data, corresponding lifetimes τₙ representative of a decay time associated with the fluorophores when placed in the sample, and
identify at least one of the tissue types based on a difference between the computed coefficients τₙ and corresponding intrinsic lifetimes of the fluorophores.

38. The computer program product of claim 37, wherein the sample has an absorption coefficients μₐ such that the fluorophore lifetimes are longer than the intrinsic absorption time scale defined by (vμₐ)⁻¹.
